(19) United States
(12) Patent Application Publication
(10) Pub. No.: US 2024/0263274 A1
(43) Pub. Date: Aug. 8, 2024

(54) METHOD FOR SEPARATING RADIONUCLIDES FROM ORES, ORE CONCENTRATES, AND TAILINGS

(71) Applicant: UNIQUEST PTY LIMITED, Brisbane, Queeensland (AU)

(72) Inventors: James VAUGHAN, Brisbane, Queensland (AU); Weng FU, Brisbane, Queensland (AU)

(21) Appl. No.: 18/559,931

(22) PCT Filed: May 11, 2021
(86) PCT No.: PCT/AU2021/050433

§ 371 Date: Nov. 9, 2023

(51) Int. Cl. C22B 60/00; C22B 1/02; C22B 3/06; C22B 3/42

(52) U.S. Cl. CPC C22B 60/00; C22B 1/02; C22B 3/06; C22B 3/42

(57) ABSTRACT

A method for separating radionuclides from ores, ore concentrates, and tailings or mixtures of two or more thereof comprising the steps of (a) providing an ore, ore concentrate, or tailings, or a mixture of two or more thereof in which radionuclides have been liberated onto surfaces of particles of the ore, ore concentrate or tailings or mixtures of two or more thereof, (b) forming a pulp or slurry comprising the ore, ore concentrate or tailings or a mixture or two or more thereof from step (a), water or an aqueous solution, and an ion exchange resin to cause the radionuclides to load onto the resin, and (c) separating the resin from other solids present in the pulp or slurry.

### TECHNICAL FIELD

The present invention relates to a method for separating radionuclides from ores, ore concentrates, and tailings.

### BACKGROUND ART

In the mining industry, radioactive elements are widespread in coal, copper, bauxite, phosphate rock, and ores containing tin, tantalum, niobium, rare earths and gold deposits. The radionuclides of interest include long-lived radionuclides such as uranium-238 (²³⁸U), uranium-235 (²³⁵U) and thorium-232 (²³²Th) and their radioactive decay products (such as long-lived isotopes of ²³⁴U, ²³⁰Th, ²²⁸Th, ²²⁶Ra, ²²⁸Ra, ²¹⁰Pb, and ²¹⁰Po). Mineral processing operations can potentially concentrate the radioactive element bearing minerals in the ore concentrate and/or tailings, which leads to large amount of radioactive materials that can be problematic in terms of occupational health and safety, meeting environmental and transport legislation, posing a challenge for long-term storage of process residues and mine tailings and causing difficulties if it is desired to further process the material. Thus, it can be necessary to reduce radionuclides to very low values in order to avoid the potential hazardous effects on the workers and ambient environment and a cost-effective option is desired.

Hydrometallurgical leaching chemically liberates metals from solid materials. Leaching is the starting point for most hydrometallurgical processes. The chief objective of leaching processes is to selectively dissolve a maximum amount of the element or compound of interest. Hydrometallurgical treatments have proven to be effective method for removing radionuclides from ores, ore concentrate or tailings containing radioactive minerals. Various hydrometallurgical processes have been developed for radionuclide removal.

K. E. Haque et al (Hydrometallurgy, 11(1983) 91-103) disclosed a chloride leach using both hydrochloric acid and chloride salts for uranium mill tailings and their flotation concentration. The best hydrochloric acid leach residues obtained from the pyrite concentrate contained 0.005% uranium, 0.038% thorium, and 2.22 Bq/g ²²⁶Ra, and from the radioactive concentrate contained 0.004% uranium, 0.017% thorium, and 14.4 Bq/g radium solids. However, results indicate that neither acid chloride nor salt chloride leaching is fully effective in reducing tailings to be free of radionuclides in a single stage and Haque postulated that multiple stages of leaching would be required, which can be costly. If hydrochloric acid is used, unacceptably high amount of gangue mineral dissolution will occur with oxide tailings, for example.

US2015/0329938 A1 discloses a high-temperature hydrometallurgical leach process for the removal of uranium, thorium, radium, lead, bismuth and polonium and/or other radionuclides from a radioactive copper ore concentrate. This non-oxidative (NONOX) leach process uses a sulphate and chloride containing lixiviant at elevated temperature (160-240° C.) in a multi-compartment autoclave. Approximately 80% Po-210 and Pb-210 removal was achieved. It is noted that the high temperature metathesis process is expensive due to capital cost of the high temperature autoclaves and associated infrastructure which are resistant to hydrochloric acid corrosion. Another significant cost arises from the high energy requirements for autoclave operation. The presence of sulfate in the nonox solution means that the process is not effective for separating ²²⁶Ra because of the low solubility of radium sulfate salts.

US2018/0010208 A1 discloses a low-temperature hydrometallurgical leach process for radionuclide removal from different ores. The lixiviants used in the process are an acid mixture containing one alkanesulfonic acid and at least one further acid (mainly hydrochloric acid or nitric acid). The leach process can effectively leach radionuclides from ore and ore concentrate at atmospheric condition (20-100° C.). It is noted that the cost of alkanesulfonic acids is over 10 times higher than generic mineral acids such as sulphuric acid, hydrochloric acid and nitric acid. There is no effective method to reuse the leached solution containing dissolved radionuclides and other impurities, leading to high operating costs for this approach.

The use of ion exchange resins in hydrometallurgy has been the focus of much research in the last few years. Compared to unit operations of precipitation, crystallization, solvent extraction, ion exchange resins are quite competitive for separating target metal ions from impure leach solutions. The direct recoveries of gold, nickel and uranium from viscous slurry or pulp by resin-in-pulp (RIP) technology are applied in industry. The advantages of RIP include the elimination of inefficiencies associated with conventional solid/liquid separation due to the inherent entrainment of solution with the solids with fine-particle-size distributions as well as the tendency for losses due to surface sorption.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a method for separating radionuclides from ores, ore concentrates, and tailings, which may at least partially overcome at least one of the abovementioned disadvantages or provide the consumer with a useful or commercial choice.

With the foregoing in view, the present invention in one form, resides broadly in a method for separating radionuclides from ores, ore concentrates, and tailings or mixtures of two or more thereof comprising the steps of (a) providing an ore, ore concentrate, or tailings, or a mixture of two or more thereof in which radionuclides have been liberated onto surfaces of particles of the ore, ore concentrate or tailings or mixtures of two or more thereof, (b) forming a pulp or slurry comprising the ore, ore concentrate or tailings or a mixture or two or more thereof from step (a), water or an aqueous solution, and an ion exchange resin to cause the radionuclides to load onto the resin, and (c) separating the resin from other solids present in the pulp or slurry.

In one embodiment, step (a) comprises the step of leaching an ore, ore concentrate, or tailings, or a mixture of two or more thereof containing radionuclides with an acid to chemically liberate the contained radionuclides in the ore, ore concentrate, or tailings, or a mixture of two or more thereof onto surfaces of particles of the ore, ore concentrate, or tailings, or a mixture of two or more thereof.

In another embodiment, the ore, ore concentrate, or tailings, or a mixture of two or more thereof has undergone a prior treatment in another processing plant or in another part of a processing plant that liberated the radionuclides onto the surfaces of the particles of the ore, ore concentrate, or tailings, or a mixture of two or more thereof. For example, the ore, ore concentrate, or tailings, or a mixture of two or more thereof may have been subject to an acid leaching step and the ore, ore concentrate, or tailings, or a mixture of two or more thereof provided to step (a) may be a solid residue from that acid leaching step. Alternatively, the ore, ore concentrate, or tailings, or a mixture of two or more thereof may have undergone a roasting step. Alternatively, the ore, ore concentrate, or tailings, or a mixture of two or more thereof may have undergone a roasting step followed by an aqueous leaching step or an acidic leaching step.

In one embodiment, the ore, ore concentrate, or tailings, or a mixture of two or more thereof comprises particulate material having valuable minerals present in the form of sulphides and step (a) comprises leaching the particulate material with an acid to liberate the radionuclides onto surfaces of the particulate material.

In another embodiment, the ore, ore concentrate, or tailings, or a mixture of two or more thereof comprises particulate material having valuable minerals present in the form of mixed oxides-sulphides and step (a) comprises leaching the particulate material with an acid to liberate the radionuclides onto surfaces of the particulate material.

In one embodiment, step (a) comprises leaching the ore, ore concentrate, or tailings, or a mixture of two or more thereof with an acid to solubilise radionuclides and subsequently having one or more of the radionuclides precipitate onto surfaces of the particles or adsorb onto surfaces of the particles. In this manner, radionuclides that were originally present beneath the surface or locked into the mineralogy of the particles are liberated onto the surface of the particles. In this embodiment, some of the radionuclides may remain in solution whilst one or more of the other radionuclides precipitate onto or adsorb onto the surfaces of the particles.

In one embodiment, the ore, ore concentrate, or tailings, or a mixture of two or more thereof is leached with a mineral acid selected from sulphuric acid, hydrochloric acid, nitric acid, and mixtures of two or more thereof. In one embodiment, the mineral acid comprises sulphuric acid.

In one embodiment, the acid used in step (a) has a concentration of from 0.5M to 6M, or from 1M to 6M, or from 1M to 5M, or about 3M. The present invention encompasses any suitable acid concentration that can be used in step (a).

In embodiments of step (a) where acid leaching is occurring, the acid leaching may take place at a temperature of from ambient temperature up to elevated temperatures well above 100° C. If temperatures above the atmospheric boiling point are used, pressure leaching will be required. The temperature in step (a) may range from ambient temperature up to 240° C. or above.

In embodiments of step (a) that use acid leaching, the leaching can be conducted in a number of different ways as known to persons skilled in the art. These include high pressure leaching, agitation leaching, heap leaching, or a combination of these methods.

In one embodiment, step (a) contacts the ore, ore concentrate, or tailings, or a mixture of two or more thereof with an acid and a residence time of from 1 hour to 24 hours, from two hours to 18 hours, or from 5 hours to 15 hours, or for about 12 hours. Other residence times outside these values may also be used.

In one embodiment of step (a), more than 50% of the radionuclides in the ore, ore concentrate, or tailings, or a mixture of two or more thereof are present on the surface of the particles of the ore, ore concentrate, or tailings, or a mixture of two or more thereof, or more than 60% of the radionuclides, or more than 70% of the radionuclides, or more than 80% of the radionuclides, or more than 90% of the radionuclides, or more than 95% of the radionuclides are present on the surface of the particles of the ore, ore concentrate, or tailings, or a mixture of two or more thereof. These percentages are given as weight percentages.

In one embodiment, the ore, ore concentrate, or tailings or mixture of two or more thereof that is fed to step (b) originates from sulphuric acid pressure leaching of a radioactive ore, ore concentrate, tailings and other process by-products, or originates from sulphuric acid atmospheric leaching of a radioactive ore, ore concentrate, tailings and other process by-products, or originates from hydrochloric acid atmospheric leaching of a radioactive ore, ore concentrate, tailings and other process by-products, or originates from nitric acid atmospheric leaching of a radioactive ore, ore concentrate, tailings and other process by-products, or originates from a radioactive ore or concentrate selected from the group consisting of sulfide, mixed oxide-sulfide and mixtures thereof.

Step (b) comprises forming a pulp or slurry of the ore, ore concentrate, or tailings, or a mixture of two or more thereof in which the radionuclides have been liberated onto the surface of the particles by mixing the ore, ore concentrate, or tailings, or a mixture of two or more thereof. The pulp or slurry may be formed by mixing the ore, ore concentrate, or tailings, or a mixture of two or more thereof from step (a) with water or an aqueous solution and an ion exchange resin.

Step (b) may be conducted at a pH of from 1 to 9, preferably from 1 to 7, more preferably from 1 to 5, or about 3. However, the pH in this step can vary depending on the ion exchange functional group in the resin and the composition of the slurry.

In step (b) the radionuclides go into solution and are then taken up by the resin to load the radionuclides onto the resin. Without wishing to be bound by theory, the present inventors believe that removal of the radionuclides from solution by the resin drives further dissolution of radionuclides from the particles of ore, ore concentrate, or tailings, or a mixture of two or more thereof, with the further dissolved radionuclides also being taken up by the resin. This drives greater removal of radionuclides from the particles of ore, ore concentrate, or tailings, or a mixture of two or more thereof.

In some embodiments, the pH in step (b) is maintained at or near a desired value by addition of appropriate alkali materials or neutralizing agents or acids. For example, if take-up of the radionuclides into the resin causes the pH of the liquid phase to increase, an alkali or neutralizing agent may be added to maintain the pH at or near the desired value. The alkali or neutralizing agent may be one or more of alkali oxides, alkali hydroxides, alkali carbonates, alkaline earth oxides, alkaline earth hydroxides, alkaline earth carbonates, and mixtures thereof. Sodium hydroxide may be used. The alkali or neutralizing agent may be added when mixing the ion exchange resin with the ore, ore concentrate, tailings or mixtures of two or more thereof. Alternatively, the alkali or neutralizing agent may be added to the slurry or pulp of the ion exchange resin and the ore, ore concentrate, tailings or mixtures of two or more thereof.

In step (b), the repulped slurry is suitably contacted at atmospheric pressure with an ion exchange resin. The chemically liberated radionuclides are selectively adsorbed onto the resin.

In one embodiment, the ion exchange resin preferentially or selectively takes up radionuclides over other metal ions, such as manganese, magnesium, and calcium. In some embodiments, the ion exchange resin selectively removes radionuclides over other metal ions in solution. In other embodiments, the ion exchange resin removes the radionuclides and metal ions from the solution.

In one embodiment, the ion exchange resin contains solvent that is impregnated in the porous resin bead.

In one embodiment, the resin contains organophosphorus functional groups, selected from the group consisting of dialkylphosphinic acid, dialkyldithiophosphinic acid, diaklylphosphoric acid, diaklylphosphonic acid, aminomethylphosphonic acid and mixtures thereof. The functional groups have a high selectivity of radionuclides over other metal ions such as manganese, magnesium, and calcium. Suitable resins include Lewatit TP 272, Lewatit VP OC 1026, Lewatit MonoPlus TP260, Purolite MTX7010, Purolite MTS9500, and Purolite MTX8010.

In another embodiment, the resin contains nitrogen-containing functional groups, such as iminodiacetate functional groups or bis-picolylamine functional groups. The nitrogen-containing functional groups may be bonded to the resin or bonded to polymer beads. The iminodiacetate functional groups may be bonded to the resin or bonded to polymer beads. In some embodiments, close control of pH may not be required where the ion-exchange resin contains nitrogen-containing functional groups or iminodiacetate functional groups or bis-picolylamine functional groups in order for the resin to take up the radionuclides. Examples of suitable resin having nitrogne-containing functional groups include Lewatit TP 207, 208 and 209, Purolite S930Plus, M4195, and Puromet MTS9600. Other resins having nitrogen-containing functional groups may also be used.

Step (b) can be carried out at any suitable temperature up to the stability limit of the resin. This temperature is dependent upon the particular resin being used. For some resins, the maximum temperature for step (b) may be up to 100° C. and step (b) may take place at any temperature between 0° C. and 100° C. Different resins may require a lower maximum temperature. The skilled person would be readily able to determine an appropriate temperature for step (b), which may need to take into account the maximum stability temperature of the resin, process kinetics and operating costs.

In one embodiment, the redox (oxidation-reduction) potential (Eh) of the slurry in step (b) is adjusted by the addition of a reductant to reduce any trivalent iron to the bivalent state. Suitable reductants may be, for example, elemental iron or aluminium, or a sulphide containing mineral. By minimizing the ferric iron extraction, the radionuclide extraction is optimized by providing optimum selective loading of radionuclides onto the resin. In another embodiment, step (b) further comprises adding a sufficient amount of a reductant to reduce trivalent iron to bivalent iron.

The slurry or pulp in step (b) may include the ore, ore concentrate, or tailings, or a mixture of two or more thereof from step (a) in an amount of from 5% to 50% by weight, or from 10% to 40% by weight, or from 15% to 30% by weight, or about 20% by weight. The slurry or pulp in step (b) may contain from 2% to 25% by weight resin, or from 5% to 20% by weight resin, or from 5% to 15% by weight resin, or about 5% to 10% by weight resin. Differing amounts of the ore, ore concentrate, or tailings, or a mixture of two or more thereof and resin may be used, depending upon the process design parameters for step (b) and depending upon the capacity of the resin being used.

The slurry or pulp in step (b) is suitably stirred or agitated to maintain the solid components in suspension.

The residence time in step (b) should be sufficiently long to ensure that a maximum amount or an optimum amount of the radionuclides are loaded onto the resin. Experimental work conducted by the present inventors has indicated that a residence time of from 1 to 8 hours should be satisfactory, with 3 hours providing satisfactory results. Residence times that are different to these values may also be used.

Step (b) may comprise a plurality of steps in which the slurry is contacted with the resin, followed by separating the slurry from the resin and then further contacting the slurry with the resin. The plurality of steps may comprise a counter current contacting process.

Once step (b) has been operated for the desired time or to the desired extent, the loaded ion exchange resin is separated from the particles of the ore, ore concentrate, or tailings, or a mixture of two or more thereof. Any known separation process that is suitable may be used to separate the ion exchange resin from the particles of the ore, ore concentrate, or tailings, or a mixture of two or more thereof.

In one embodiment, the ion exchange resin has particle size that is larger than the particle size of the ore, ore concentrate, or tailings, or a mixture of two or more thereof and a separation step based upon particle sizes use. For example, the solids or pulp or slurry from step (b) may be passed through a sieve or a screen having an opening that is larger than the particles of ore, ore concentrate, or tailings, or a mixture of two or more thereof and smaller than the particles of the resin to thereby separate the particles of resin from the ore, ore concentrate, or tailings, or a mixture of two or more thereof. The resin particles are retained on the screen or sieve and the other particles passed through the screen or sieve to thereby separate the particles.

In another embodiment, gravity separation methods may be used to separate the resin from the ore, ore concentrate, or tailings, or a mixture of two or more thereof. The resin will generally have a lower specific gravity than the ore, ore concentrate, or tailings, or a mixture of two or more thereof, which allows for gravity separation techniques to be used.

The solid residue of the ore, ore concentrate, or tailings, or a mixture of two or more thereof from step (c) comprises a solid residue having reduced radionuclide content. The solid residue can be treated as a final product. In one embodiment, the solid residue is disposed or discarded. In another embodiment, the solid residue is subject to further treatment to remove and/or recover other minerals therefrom. In another embodiment, the solid residue may be used as a landfill, as a road base or the like. The solid residue may be washed with water prior to any further downstream uses or discard or disposal.

In one embodiment, the solid residue having reduced radionuclide content is further treated to recover valuable metal or metals therefrom. For example, the solid that is being fed to the process of the present invention may comprise a rare-earth-containing tailings and the solid residue having reduced radionuclide content may be treated to recover rare-earth metals or rare earth compounds therefrom. In another embodiment, the solid that is being fed to the process of the present invention comprises a copper concentrate and the solid residue having reduced radionuclide content may be treated to recover copper therefrom.

In embodiments where the solid being treated contains valuable minerals, any ions of the valuable minerals that are taken up by the ion exchange resin may be recovered separately, if desired.

The solid residue from step (c) may be subject to solid/liquid separation following separation from the resin.

In one embodiment, the loaded resin that has been separated from the solid residue is treated to elute the radionuclides therefrom. The loaded resin may be washed prior to elution of the radionuclides. The treated resin may then the returned to step (b).

The radionuclides may be eluted from the loaded resin by contacting the loaded resin with an acid, such as a mineral acid. In one embodiment, the loaded resin is contacted within aqueous mineral acid solution, such as hydrochloric acid, nitric acid is sulphuric acid. The concentration of the acid solution may be from about 0.5 to 6M, suitably about 1M. The resulting eluate is a concentrated radionuclide-bearing solution from which radionuclides can be recovered by methods known to those skilled in the art. It may also be possible to recover other metals from the eluate, such as copper.

In a second aspect, the present invention provides a method for separating radionuclides from ores, ore concentrates, and tailings comprising the steps of (a) providing an ore, ore concentrate, or tailings, or a mixture of two or more thereof in which radionuclides have been liberated onto surfaces of particles of the ore, ore concentrate or tailings or mixtures of two or more thereof, (b) mixing the ore, ore concentrate, or tailings, or a mixture of two or more thereof from step (a) with a hydrochloric acid solution to extract radionuclides into solution, and (c) separating the solution from a solid residue.

Step (a) of the second aspect of the present invention may involve the same steps as step (a) of the first aspect of the present invention. For brevity of description, these features need not be described further.

Step (b) of the second aspect of the present invention may use HCl acid having a concentration of 1M to 6M or 4 to 6M, or about 5M. Step (b) of the second aspect of the present invention forms a slurry or pulp of the ore, ore concentrate, or tailings, or a mixture of two or more thereof and hydrochloric acid solution. The slurry or pulp may have a solids content of between 5% and 50% by weight, or 10% and 30% by weight, or about 20% by weight.

In some embodiments, the temperature in step (b) of the second aspect of the present invention is elevated, preferably 60° C. up to the atmospheric boiling point of the slurry, or 60 to 95° C., or 70 to 90° C., or about 90° C.

Once the radionuclides have gone into the hydrochloric acid solution, the loaded hydrochloric acid solution is separated from the solids, which form a solid residue. Any solid/liquid separation process known to the person skilled in the art may be used. Filtration is an example of one such technique.

The solid residue may be washed and disposed of or subjected to further treatment or further use.

The loaded hydrochloric acid solution containing dissolved radionuclides may be treated to remove the radionuclides therefrom. This may regenerate the hydrochloric acid solution for further use in step (b). For example, D. A. White et al (Hydrometallurgy, 36(1994) 161-168), the entire contents of which are incorporated by cross reference, disclosed a solvent extraction method to remove uranium (VI) from concentrated hydrochloric acid solutions (4-6 M). In this method, the best results show that 40% tri-n-octylamine (TOA) dissolved in benzene as the organic phase extracted all of U (VI) from aqueous phase containing 4 M HCl.

The present invention is capable of removing a number of radionuclides from ores, ore concentrates, tailings or mixtures of two or more thereof. Radionuclides that may be removed by the present invention include uranium-238 (²³⁸U), uranium-235 (²³⁵U) and thorium-232 (²³²Th), and isotopes of ²³⁴U, ²³⁰Th, ²²⁸Th, ²²⁶Ra, ²²⁸Ra, ²¹⁰Pb, and ²¹⁰Po. Other radionuclides may also be removed. Radium and lead radionuclides can be removed by the process of the present invention to a large extent.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 shows a flowsheet of one embodiment of the present invention.

### DESCRIPTION OF EMBODIMENTS

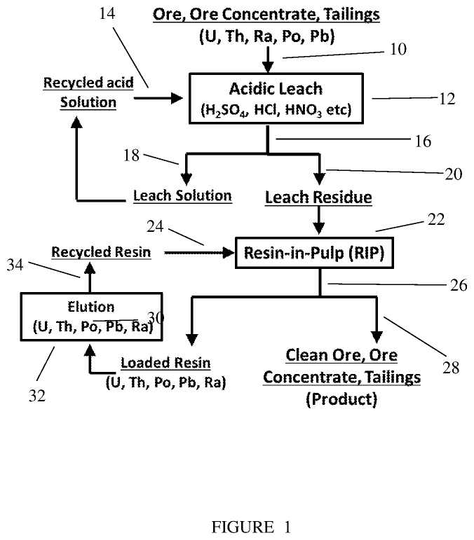

Referring to FIG. 1, a radioactive ore, ore concentrate, or tailing 10 is leached with mineral acid 14 in leaching step 12. The leaching can be done in different ways, known to anyone skilled in the art. This include high pressure leaching, agitation leaching, heap leaching, or combination of these methods. The objective of the leaching process is to chemically liberate radionuclides from uranium-bearing minerals and partially dissolve the radionuclides into acidic leach solution. In one embodiment, the leaching is accomplished using a mineral acid selected from the group consisting of sulfuric acid, hydrochloric acid, nitric acid, and mixtures thereof.

The slurry 16 that is removed from the leaching step 12 is subjected to a solid/liquid separation to form a leach solution 18 and a solid residue 20. The leach solution 18 may be treated to remove dissolved radionuclides therefrom and then recycled to the leach step 12.

The solid leach residue 20 is then sent to step (b), which comprises resin in pulp step 22. As an alternative, the solids that are sent to resin in pulp step 22 may originate from an acid leach residue that occurred in another part of the plant or in another plant. In yet another alternative, the solids sent to resin in pulp step 22 may originate from ore, or concentrate, or tailings directly without an acid leach step.

In step 22, the leach residue 20 is re-pulped with water and an ion exchange resin 24. The repulped slurry may originate from acid leach residue. In yet another alternative, the repulped slurry may originate from ore, ore concentrate, or tailings directly without acid leach step.

The repulped slurry is contacted at atmospheric pressure with an ion exchange resin in step 24. The chemically liberated radionuclides are selectively adsorbed onto the resin. A suitable resin contains organophosphorus functional groups, selected from the group consisting of dialkylphosphinic acid, dialkyldithiophosphinic acid, diaklylphosphoric acid, diaklylphosphonic acid, aminomethylphosphonic acid and mixtures thereof. The functional groups have a high selectivity of radionuclides over other metal ions such as manganese, magnesium, and calcium. Suitable resins include Lewatit TP 272, Lewatit VP OC 1026, Lewatit MonoPlus TP260, Purolite MTX7010, Purolite MTS9500, and Purolite MTX8010. Other resins, including resins having iminodiacetic acid functional groups and/or bis-picolylamine functional groups may also be used.

An additional variable is that during resin in pulp (RIP), the redox (oxidation-reduction) potential (Eh) of the slurry is adjusted by the addition of a reductant (such as elemental iron or aluminium, or a sulphide containing mineral), to reduce any trivalent iron to the bivalent state. By minimizing the ferric iron extraction, the radionuclide extraction is optimized by providing optimum selective loading of radionuclides onto resin.

During the RIP, the pH is maintained at set-point by addition of NaOH or mineral acids to optimize the radioactive metal extraction and provide for optimum selective loading of radionuclides onto resin. Generally, the pH of the slurry is maintained between about 1 and about 7, preferably about 3, however, this can vary depending on the ion exchange functional group and the composition of the slurry.

The RIP process 24 can be carried out at any suitable temperature up to the stability limit of the resin, which is at least 60° C. In general, the reaction rate will increase with temperature. Therefore, the preferred temperature is between about 400 and 60° C.

After the radionuclides are loaded onto the resin in step 24, the pulp 26 is removed and the loaded resin 30 is separated from the radionuclide-depleted leach slurry 28 (repulped leach residue). This separation can be accomplished physically by screening the larger resin beads from the finer repulped leach residue and barren liquid. The RIP residue 28 can be treated as final product. The radionuclide-loaded resin 30 is washed and the radionuclides are eluted in a separate circuit 32. The radionuclides may be eluted using an aqueous mineral acid solution, such as HCl, HNO₃, or H₂SO₄. The concentration of the acid solution in the elution step 32 is from about 0.5 to 6M, preferably about 1M. The resultant eluate is a concentrated radionuclide-bearing solution from which radionuclide can be recovered by methods known to those skilled in the art. The stripped resin 34 is returned to the contacting step of the process.

### Example 1

Two types of copper flotation concentrates are used as test substances shown in Table 1. The copper ore flotation concentrate 1 with the high radionuclide contents is used EXAMPLE 1. The particle-size distribution (PSD) data D80 for flotation concentrate 1 is around 20 μm. In this first stage, H₂SO₄ leaching with 20 wt % mineral content in a batch reactor at 90° C. for 12 hours to separate U and Th from the copper sulphide minerals. The majority of the remainder of the radionuclides are surface-available for extraction in a second stage after being chemically liberated in the H₂S₄ leach but then either precipitating or adsorbing onto the remaining mineral surfaces. In the second stage, RIP leach with 20 wt % minerals and 10 wt % resin beads (impregnated with diaklylphosphoric acid) in a batch reactor at 50° C. for 3 hours is used to extract the liberated radionuclides in Table 2. Alternatively, acidic chloride leach (5M chloride) with 20 wt % mineral content in a batch reactor at 90° C. for 3 hours is also used to extract radionuclides from H₂SO₄ leach residue. The RIP second stage was more effective than the chloride second stage for all radionuclides except Po-210.

TABLE 1

| | Mineral, wt % | | | | | | | |
|---|---|---|---|---|---|---|---|---|
| | | | | | | | | Uranium- |
| | Chalcopyrite | Bornite | Chalcocite | Covellite | Pyrite | Iron- | Other | bearing |
| Type Code | CuFeS₂ | Cu₅FeS₄ | Cu₂S | CuS | FeS₂ | oxide | Gangue | Minerals |
| Copper | 41.31 | 26.82 | 6.06 | 2.64 | 8.59 | 9.22 | 5.36 | ~0.1 |
| Flotation | | | | | | | | |
| Concentrate 1 | | | | | | | | |
| (High RN | | | | | | | | |
| contents) | | | | | | | | |
| Copper | 64.03 | 10.20 | 0 | 0.94 | 17.12 | 5.69 | 2.02 | <0.1 |
| Flotation | | | | | | | | |
| Concentrate 2 | | | | | | | | |
| (Low RN | | | | | | | | |
| contents) | | | | | | | | |

TABLE 2

| | Cu % | ²³⁸U, | ²³⁰Th | ²¹⁰Pb | ²²⁶Ra | ²¹⁰Po |
|---|---|---|---|---|---|---|
| Mineral Name | dissolution | Bq/g | Bq/g | Bq/g | Bq/g | Bq/g |
| Copper Flotation | — | 15.0 | 13.8 | 17.5 | 13.4 | 18 |
| Concentrate 1 | | | | | | |
| (High radionuclide | | | | | | |
| contents) | | | | | | |
| H₂SO₄ Leach Residue | 7.8 | 0.5 | 1.7 | 19.8 | 17.5 | 23 |
| (1st stage) | | | | | | |
| RIP Leach Product | 9.2 | 0.84 | 1.3 | 2.0 | 1.4 | 17 |
| (2nd stage) | | | | | | |
| Chloride Leach Product | 17.3 | 0.9 | 1.4 | 2.6 | 5.1 | 6.9 |
| (2nd stage) | | | | | | |

### Example 2

The copper ore flotation concentrate 2 with the low radionuclide contents is used EXAMPLE 2. The particle-size distribution (PSD) data D80 for flotation concentrate 1 is around 10 μm. In this first stage, H₂SO₄ leaching with 20 wt % mineral content in a batch reactor at 90° C. for 12 hours to separate U and Th from the copper sulphide minerals. The majority of the remainder of the radionuclides are surface-available for extraction in a second stage after being chemically liberated in the H₂SO₄ leach but then either precipitating or adsorbing onto the remaining mineral surfaces. In the second stage, RIP leach with 20 wt % minerals and 10 wt % resin beads (impregnated with diaklylphosphoric acid) in a batch reactor at 50° C. for 3 hours is used to extract the liberated radionuclides in Table 2. Alternatively, acidic chloride leach (5M chloride) with 20 wt % mineral content in a batch reactor at 90° C. for 3 hours is also used to extract radionuclides from H₂SO₄ leach residue. The RIP second stage was more effective than the chloride second stage for all radionuclides except Po-210.

TABLE 3

| | Cu % | ²³⁸U, | ²³⁰Th | ²¹⁰Pb | ²²⁶Ra | ²¹⁰Po |
|---|---|---|---|---|---|---|
| Mineral Name | dissolution | Bq/g | Bq/g | Bq/g | Bq/g | Bq/g |
| Copper Flotation | — | 1.02 | 1.28 | 3.6 | 0.83 | 2.7 |
| Concentrate 2 | | | | | | |
| (Low radionuclide | | | | | | |
| contents) | | | | | | |
| H₂SO₄ Leach Residue | 5.4 | 0.16 | 0.07 | 3.1 | 0.83 | 2.7 |
| (1st stage) | | | | | | |
| RIP Leach Product | 6.5 | 0.13 | 0.12 | 0.87 | 0.15 | 1.5 |
| (2nd stage) | | | | | | |
| Chloride Leach Product | 12.8 | 0.14 | 0.11 | 0.9 | 0.73 | 0.94 |
| (2nd stage) | | | | | | |

### Example 3

Uranium metallurgical process tailings are treated to remove radionuclides by RIP using VPOC 1026 resin and then acid leached. The radionuclide deportment in the process solids are shown in Table 4.

In the first RIP stage, the slurry content consisted of 20 wt % mineral solids and 10 wt % resin beads (impregnated with diaklylphosphoric acid) in a batch reactor at 30° C. for a residence time of 3 hours. As seen in Table 4, the RIP treatment was effective for removing the radionuclides (Pb-210 and Ra-226).

In this second stage, the solid product from the RIP stage was leached in H₂SO₄ at 20 wt % solids in a batch reactor at 30° C. for 24 hours which was effective in separating the remaining radionuclides U-238 and Th-230.

TABLE 4

| | Sample Name + | Po-210 | Pb-210 | Ra-226 | U-238 | Th-230 |
|---|---|---|---|---|---|---|
| No. | Test Conditions | Bq/g | Bq/g | Bq/g | Bq/g | Bq/g |
| 1 | Uranium Tailing | 16.6 | 18.0 | 13.2 | 1.10 | 8.9 |
| 2 | VPOC 1026 RIP | 15.6 | 4.8 | 2.7 | 1.13 | 9.6 |
| | Product | | | | | |
| | (1st stage) | | | | | |
| 3 | H₂SO₄ Leach | not | 2.4 | 3.7 | 0.17 | 0.3 |
| | Residue | mea- | | | | |
| | (2nd stage) | sured | | | | |

### Example 4

Uranium metallurgical process tailings are treated to remove radionuclides by RIP using TP209 resin and then acid leached. The radionuclide deportment in the process solids are shown in Table 5.

In the first RIP stage, the slurry content consisted of 20 wt % mineral solids and 5 wt % resin beads (iminodiacetate functional group) in a batch reactor at 30° C. for a residence time of 3 hours. As seen in Table 5, the RIP treatment was effective for removing the radionuclides (Pb-210 and Ra-226).

In this second stage, H₂SO₄ leaching with 20 wt % mineral content in a batch reactor at 30° C. for 24 hours was used to separate U and Th from the uranium tailing minerals.

TABLE 5

| Sample Name + | Po-210 | Pb-210 | Ra-226 | U-238 | Th-230 |
|---|---|---|---|---|---|
| Conditions | Bq/g | Bq/g | Bq/g | Bq/g | Bq/g |
| Uranium Tailing | 16.6 | 18.0 | 13.2 | 1.10 | 8.9 |
| TP209 RIP Product | 16.6 | 4.3 | 2.5 | 0.99 | 9.5 |
| (1st stage) | | | | | |
| H₂SO₄ Leach Residue | not | 3.3 | 1.9 | 0.07 | 0.6 |
| (2nd stage) | measured | | | | |

Although the resin-in-pulp conditions used in example 4 was at a temperature of around 30° C., the resin-in-pulp step could be operated at a temperature of up to about 80° C. before the resin beads get compromised. In general terms, the resin-in-pulp steps of the present invention can be operated at any temperature up to the temperature at which the resin beads get compromised.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1.-22. (canceled)

23. A method for separating radionuclides from ores, ore concentrates, and tailings or mixtures of two or more thereof comprising the steps of (a) providing an ore, ore concentrate, or tailings, or a mixture of two or more thereof in which radionuclides have been liberated onto surfaces of particles of the ore, ore concentrate or tailings or mixtures of two or more thereof, (b) forming a pulp or slurry comprising the ore, ore concentrate or tailings or a mixture or two or more thereof from step (a), water or an aqueous solution, and an ion exchange resin to cause the radionuclides to load onto the resin, and (c) separating the resin from other solids present in the pulp or slurry.

24. The method as claimed in claim 23, wherein ore, ore concentrate, or tailings, or a mixture of two or more thereof in which radionuclides have been liberated onto surfaces of particles of the ore, ore concentrate or tailings or mixtures of two or more thereof provided in step (a) is prepared by a process comprising one or more steps selected from the group consisting of
leaching an ore, ore concentrate, or tailings, or a mixture of two or more thereof containing radionuclides with an acid to chemically liberate the contained radionuclides onto surfaces of particles of the ore, ore concentrate, or tailings, or a mixture of two or more thereof,
roasting an ore, ore concentrate, or tailings, or a mixture of two or more thereof containing radionuclides, and
roasting an ore, ore concentrate, or tailings, or a mixture of two or more thereof containing radionuclides and following said roasting with an aqueous leaching step or an acidic leaching step.

25. The method as claimed in claim 24 wherein the ore, ore concentrate, or tailings, or a mixture of two or more thereof provided in step (a) is prepared by leaching an ore, ore concentrate, or tailings, or a mixture of two or more thereof containing radionuclides with a mineral acid selected from sulphuric acid, hydrochloric acid, and nitric acid, having a concentration of from 0.5M to 6M.

26. The method as claimed in claim 23 wherein more than 50% by weight of the radionuclides in the ore, ore concentrate, or tailings, or a mixture of two or more thereof are present on the surface of the particles of the ore, ore concentrate, or tailings, or a mixture of two or more thereof provided in step (a).

27. The method as claimed in claim 23 wherein the ore, ore concentrate, or tailings or mixture of two or more thereof that is fed to step (b)
originates from sulphuric acid pressure leaching of a radioactive ore, ore concentrate, tailings and other process by-products,
or originates from sulphuric acid atmospheric leaching of a radioactive ore, ore concentrate, tailings and other process by-products,
or originates from hydrochloric acid atmospheric leaching of a radioactive ore, ore concentrate, tailings and other process by-products,
or originates from nitric acid atmospheric leaching of a radioactive ore, ore concentrate, tailings and other process by products,
or originates from a radioactive ore or concentrate selected from the group consisting of sulfide, mixed oxide-sulfide and mixtures thereof.

28. The method as claimed in claim 23 wherein step (b) is conducted at a pH of from 1 to 7.

29. The method as claimed in claim 28 wherein the ion exchange resin contains solvent that is impregnated in a porous resin bead.

30. The method as claimed in claim 29 wherein the resin contains organophosphorus functional groups, selected from the group consisting of dialkylphosphinic acid, dialkyldithiophosphinic acid, diaklylphosphoric acid, diaklylphosphonic acid, aminomethylphosphonic acid and mixtures thereof.

31. The method as claimed in claim 29 wherein the resin contains nitrogen-containing functional groups, or iminodiacetate functional groups or bis-picolylamine functional groups.

32. The method as claimed in claim 28 wherein a redox (oxidation-reduction) potential (Eh) of the pulp or slurry in step (b) is adjusted by the addition of a reductant to reduce any trivalent iron to the bivalent state.

33. The method as claimed in claim 32 wherein the reductant comprises elemental iron or aluminium, or a sulphide containing mineral, or mixtures of two or more thereof.

34. The method as claimed in claim 23 wherein the slurry or pulp in step (b) includes the ore, ore concentrate, or tailings, or a mixture of two or more thereof from step (a) in an amount of from 5% to 50% by weight.

35. The method as claimed in claim 28 wherein residence time in step (b) is from 1 to 8 hours.

36. The method as claimed in claim 35 wherein loaded ion exchange resin is separated from the particles of the ore, ore concentrate, or tailings, or a mixture of two or more thereof.

37. The method as claimed in claim 36 wherein the loaded resin that has been separated from the solid residue is treated to elute the radionuclides therefrom and the treated resin then returned to step (b).
